(19) United States
(12) Patent Application Publication
(10) Pub. No.: US 2017/0331821 A1
(43) Pub. Date: Nov. 16, 2017

(54) SECURE GATEWAY SYSTEM AND METHOD

(71) Applicant: 4MT SA, Athens (GR)

(72) Inventors: Alexandros FILIPPIDIS, Albuquerque, NM (US); Nicolas JACOVIDES, Albuquerque, NM (US)

(21) Appl. No.: 15/596,930

(22) Filed: May 16, 2017

Related U.S. Application Data
(60) Provisional application No. 62/337,152, filed on May 16, 2016.

(51) Int. Cl. H04L 29/06

(52) U.S. Cl. CPC H04L 63/0876; H04L 63/02

(57) ABSTRACT

A gateway system for authenticating a transaction event, the gateway system comprising a target server that receives a transaction event information signal from a point of inquiry (POI) device, the transaction event information signal including transaction event data associated with a user device, and a gateway server that sends an approval request signal for the transaction event data to the user device, wherein the target server sends a transaction authorization signal to the POI device when the gateway server receives a transaction approval signal from the user device.

### CROSS REFERENCE TO PRIOR APPLICATIONS

This application claims priority to and the benefit thereof from U.S. Provisional Patent Application No. 62/337,152 filed on May 16, 2016, titled A SECURE GATEWAY SYSTEM AND METHOD, the entirety of which is hereby incorporated herein by reference.

### FIELD OF THE DISCLOSURE

The present disclosure relates to a system, a method, and a computer program for identifying and authenticating a user device in real-time, and for authenticating a transaction event using the user device.

### BACKGROUND OF THE DISCLOSURE

Malicious computer programs (or malware) such as Trojan horses are used by individuals to steal data, activate or spread malware, or create back doors to gain access to devices and/or systems. The malware is frequently spread through phishing and spear phishing attacks that infect devices of unsuspecting users with “man-in-the-middle” or “man-in-the-browser,” allowing those malicious individuals to interact with websites, portals, or the like without detection. For instance, by using a man-in-the-browser attack, which infects an end user's browser, a malicious individual can manipulate web pages and transaction details in real-time without detection by the end user. Detection of man-in-the browser attacks is difficult because characteristics such as the operating system language, user agent string, and IP address data will appear the same as the user device's real data.

Man-in-the-middle attacks, on the other hand, hijack authenticated sessions on end user devices. This form of malware avoids detection by displaying or redirecting the user device to a site that displays an innocuous message (such as “The Website is Currently Unavailable,” or the like), while it initiates and carries out new transactions.

Also, Trojan attacks take over a user device or authenticated session, and strong authentication methods alone are insufficient to protect the end user device or the data on the device.

Accordingly, there exists a need for identifying and confirming with near certainty an end user device to protect users from such cyber-attacks even if their device has been infected.

### SUMMARY OF THE DISCLOSURE

The disclosure provides a novel method, system, and computer program to identify and confirm with near certainty an end user device. The disclosed system and method can protect users from malicious attacks, even where the user device may have been infected.

According to one aspect of the present disclosure, a gateway system is provided for authenticating a transaction event, the gateway system comprising: a target server that receives a transaction event information signal from a point of inquiry (POI) device, the transaction event information signal including transaction event data associated with a user device; and a gateway server that sends an approval request signal for the transaction event data to the user device, wherein the target server sends a transaction authorization signal to the POI device when the gateway server receives a transaction approval signal from the user device. The user device may comprise a security client that is activated when the user device receives the approval request signal from the gateway server. The security client may control the user device to send the transaction approval signal to the gateway server. The gateway server may determine whether the transaction approval signal is received from the user device. The target server may send a transaction event data signal to the gateway server when the transaction event information signal is received from the POI device. The gateway server may determine whether the transaction event data signal is received from the target server.

The gateway server may comprise a storage containing predefined identity (PDI) data of one or more user devices, wherein the transaction approval signal comprises the PDI data of the user device, and wherein the gateway server determines that the transaction approval signal is received from the user device when the PDI data of the user device is found in the storage. The PDI data may comprise at least one of an international mobile subscriber identity (IMSI) number, an integrated circuit card identifier (ICCID), a public key infrastructure (PKI) digital certificate, and a public key of the user device.

The gateway server may comprise a storage containing target predefined identity (TPDI) data of one or more target servers, wherein the transaction event data comprises TPDI data of the target server, and wherein the gateway server determines that the transaction event data signal is received from the target server when the TPDI data of the target server is found in the storage.

According to another aspect of the disclosure, a method is provided for operating a gateway server, the method comprising: receiving, at the gateway server, a transaction event data signal from a target server, the transaction event data signal containing transaction event data associated with a user device; sending, from the gateway server, an approval request signal to the user device associated with the transaction event data; receiving, at the gateway server, an approval signal for the transaction event from the user device; and sending, from the gateway server, an authentication success signal to the target server.

The method may further comprise determining whether the transaction event data signal is received from the target server. The transaction event data signal may be generated by the target server based on a transaction event information signal received from a point-of-inquiry (POI) device. The target server may send a transaction authorization signal to the POI device after receiving the authentication success signal. The transaction event data signal may comprise a target predefined identity (TPDI) data of the target server, wherein the gateway server comprises a storage containing TPDI data of one or more target servers, and wherein the determining comprises searching the TPDI data of the target server in storage.

The method may further comprise determining whether the approval signal for the transaction event is received from the user device. The approval signal may comprise predefined identity (PDI) data of the user device, wherein the gateway server comprises a storage containing predefined identity (PDI) data of one or more user devices, and wherein the determining comprises searching the PDI data of the user device in the storage.

According to yet another aspect of the disclosure, a gateway server is provided, comprising: a network interface that receives a transaction event data signal from a target server, the transaction event data signal comprising transaction event data associated with a user device; a data storage that stores a user device record of the user device associated with the transaction event data; and a processor that identifies the user device based on the transaction event data, wherein the network interface sends an approval request signal to the user device and receives an approval signal for the transaction event from the user device. The network interface may send an authentication success signal to the target server when the approval signal is received from the user device. The processor may determine whether the approval signal is received from the user device. The processor may determine whether the transaction event data is received from the target server.

Additional features, advantages, and embodiments of the disclosure may be set forth or apparent from consideration of the following detailed description, drawings, and claims. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced.

FIG. 1 shows an example of a gateway system for identifying and authenticating a user device in real-time, and for authenticating a communication session associated with the user device, which is constructed according to the principles of the disclosure.

FIG. 2 shows an example of a user device structure that may be included in the gateway system in FIG. 1.

FIG. 3 shows an example of a gateway server structure that may be included in the gateway system in FIG. 1.

FIG. 4 illustrates an example of an initialization process that may be carried out by the gateway system in FIG. 1.

FIG. 5 illustrates an example of an authentication process that may be carried out by the gateway system in FIG. 1.

### DETAILED DESCRIPTION OF THE DISCLOSURE

The disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure. Moreover, it is noted that like reference numerals represent similar parts throughout the several views of the drawings.

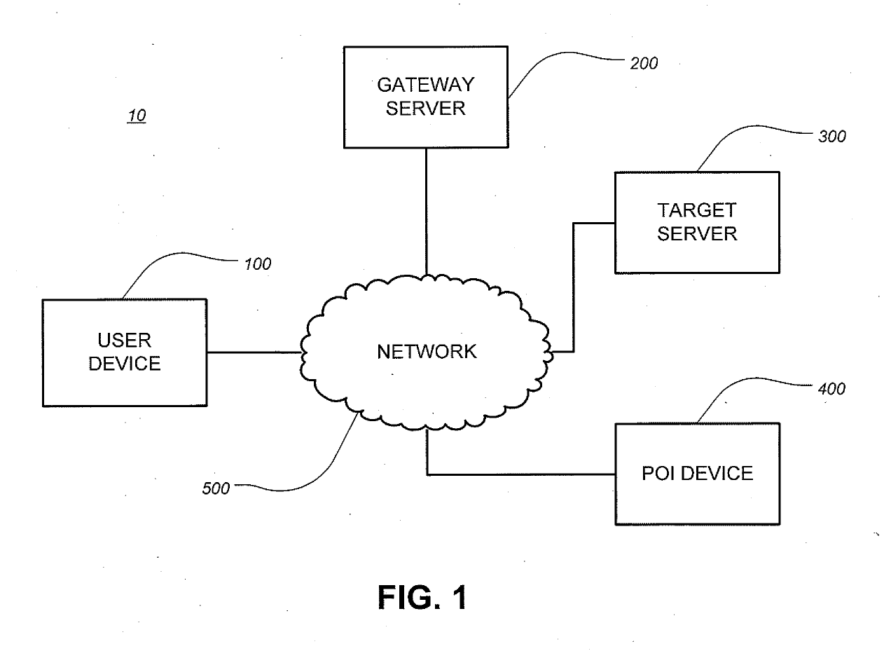

FIG. 1 shows an example of a gateway system 10 for identifying and authenticating a user device 100 in real-time, and for authenticating a transaction event associated with the user and/or user device 100. The gateway system 10 may include one or more user devices 100, a gateway server 200, one or more target servers 300, and one or more point of inquiry (POI) devices 400. The user device(s) 100, the gateway server 200, the target server(s) 300, and/or the POI device(s) 400 may be communicatively coupled to a network 500 through one or more wired or wireless communication links. The gateway server 200 and/or target server 300 may communicate with external systems, such as, for example, the user device 100, POI device 400, and the like, using standard application programming interfaces (APIs). The gateway server 200 and the target server 300 may be implemented as a single server, or a plurality of servers (such as, e.g., a server cloud).

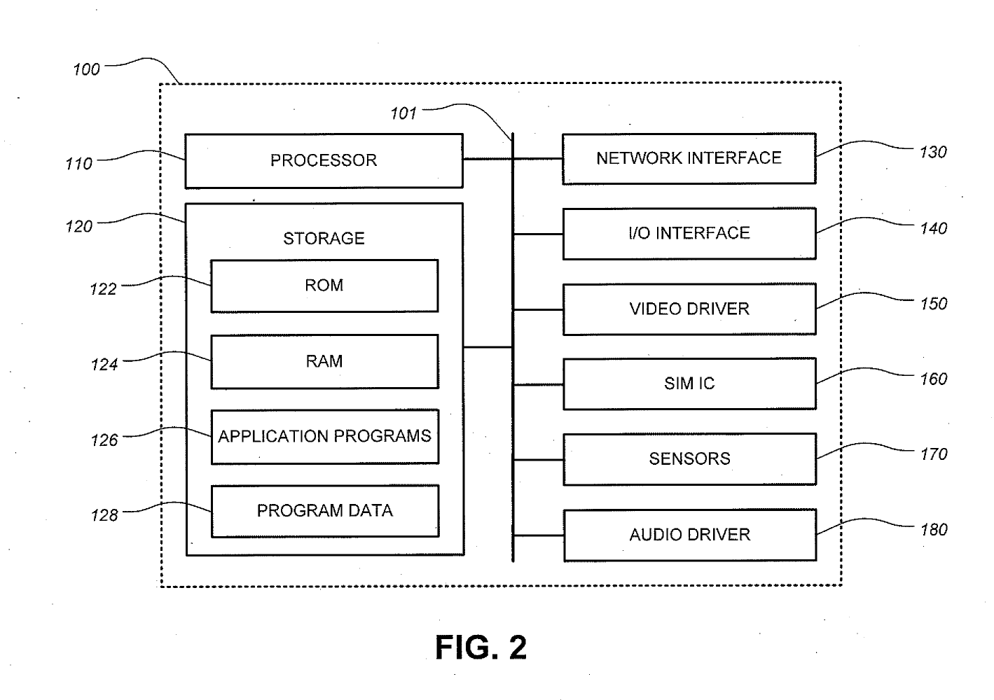

The user device 100 may include a mobile device such as a mobile phone, a smart phone, a smartwatch, a tablet, a computer, or the like. The user device 100 may include a user interface such as, for example, a display, a graphic user interface (GUI), a keyboard, a mouse, a microphone, a speaker, or the like. An example of the structure of the user device 100 is illustrated in FIG. 2.

Referring to FIG. 2, the user device 100 may include, for example, a processor 110, storage 120, a communication (or network) interface 130, an input/output (10) interface 140, a video driver 150, a SIM integrated circuit (IC) 160, one or more sensors 170, and an audio driver 180, all of which may be communicatively coupled via a bus 101. The processor 110 may include a dedicated processor that runs an operating system (OS) such as, for example, Google® Android®, Apple®i0S®, Microsoft®Windows®, or the like. The processor 110 may execute user application software, including multimedia applications that include audio, video, or the like. The processor 110 may include a microprocessor, a microcontroller, a central processing unit, a digital processing processor, etc., that are manufactured by, for example, ARM®, AMD®, MIPS®, Motorola®, Qualcomm®, Samsung®, TI®, or the like.

The system bus 101 may be any of several types of bus structures including a memory bus or memory controller, a peripheral bus, and a local bus using any of a variety of bus architectures.

The storage 120 may include, for example, read only memory (ROM) 122, random access memory (RAM) 124, and/or the like. The ROM 122 may include a basic input/output system (BIOS) that may hold basic routines that help to transfer information between components within the user device 110, such as during start. The RAM 124 may store the OS. The storage 120 may further include one or more application programs 126 and program data 128, which may be retrieved to the RAM 124 and executed by the processor 110.

The network interface 130 may include, for example, a baseband processor that controls radio frequency (RF) activities. The baseband processor may include hardware and software to provide RF communication related functions, including signal modulation, RF shifting, encoding/decoding, and the like, as well as communication protocol stacks to facilitate wireless communications using LTE, WCDMA, CDMA, Bluetooth, Wi-Fi, or the like. Through the network interface 130, the user device 100 may communicate securely using, for example, TCP/IP with the gateway server 200, the target server 300, and other devices that are equipped with the same or similar communication capabilities.

The I/O interface 140 may include one or more device interfaces that may be used to communicate with internal or peripheral devices, such as, for example, camera, display, keyboard, mouse, stylus, speaker, microphone, USB, or the like. A user may enter commands and information into the user device 100 through input devices such as, for example, a touch-screen display, a microphone, a keyboard, or any other input device known in the art.

The video driver 150 includes hardware and software to drive a display (not shown) such as, for example, an LCD, an LED, an OLED, or the like.

The subscriber identity module (SIM) integrated circuit (IC) 160 contains an integrated circuit card identifier (ICCID), an international mobile subscriber identity (IMSI) number, security authentication and ciphering information (or key information), and the like. The key may be used to identified and authenticate subscribers on mobile telephone devices. The SIM IC 160 may also include storage that can be used to store data such as, for example, user contacts, the local network, list of services accessible to the user device 100, and one or more passwords.

The sensors 170 may include, for example, a light sensor, a camera, a microphone, an accelerometer, a gyroscope, and the like.

The audio driver 180 may include hardware and software to reproduce audio signals via one or more speakers.

Referring to FIGS. 1 and 2, the user device 100 may operate in a networked environment using logical connections to one or more remote computers or servers, such as the gateway server 200, target server 300, and/or POI device 400. The logical connections include the network 500 and one or more communication links. The user device 100 may connect to the network 500 through the network interface 130, which may include a modem (not shown) or other mechanism for establishing communications over the network 500.

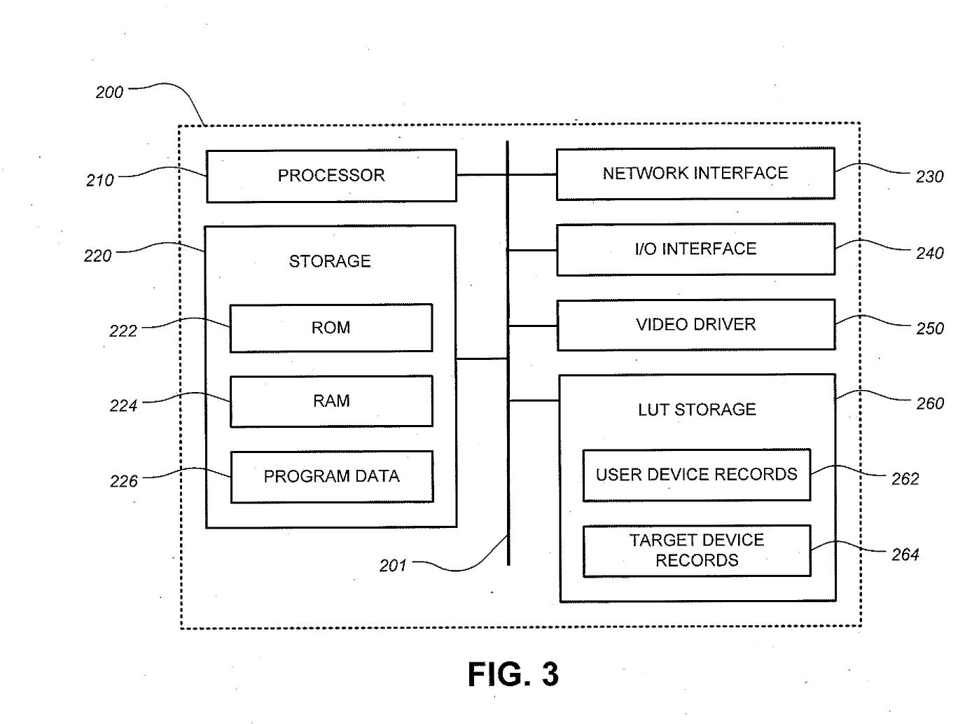

Referring to FIG. 1, the gateway server 200 may be constructed with one or more servers or computers that may be located remotely from the user device 100. The gateway server 200 may include a database (not shown), which may store a plurality of user profile records that may be associated with the owners/users of the user devices 100, respectively. An example of the structure of the gateway server 200 is illustrated in FIG. 3. The target server 300 may be constructed similar to the gateway server 200.

Referring to FIG. 3, the gateway server 200 may include a processor 210, a storage 220, a network interface 230, an I/O interface 240, a video driver 250, and a look-up-table (LUT) storage 260. The processor 210, network interface 230, I/O interface 240, and video driver 250 may be constructed and operated in a similar manner to the processor 110, network interface 130, I/O interface 140, and video driver 150 of the user device 100, respectively, which are described above with reference to FIG. 2.

Similar to the storage 120 shown in FIG. 2, the storage 220 may include the ROM 222 and the RAM 224. The ROM 222 may include a basic input/output system (BIOS) that may hold basic routines that help to transfer information between components within the gateway server 200, such as during start. The RAM 224 may contain executable code and/or data for carrying out one or more operations by the gateway server 200. The storage 220 may further include program data 226, which may be retrieved to the RAM 224 and executed by the processor 210.

The LUT storage 260 may store, for example, user device records 262 and target device records 264. Each user device record 262 may be associated with a corresponding, respective user device 100. Each user device record 262 may include predefined identity (PDI) data that identifies the corresponding user device 100. The PDI data may include, for example, an IMSI number, an ICCID number, a PKI digital certificate, a public key, or any other information related to the corresponding user device 100 that can accurately and reliably identify the corresponding user device 100 for authentication purposes. The user device records 262 may be populated from data received directly from the respective user device(s) 100, or from the respective target server(s) 300. Additionally, the user devices records 262 may be populated from batch data received from, for example, a secure database (not shown) or the target server(s) 300.

The target device records 264 may be associated with the target server 300. Each target device record 264 may include target PDI (TPDI) data that identifies a corresponding target server 300. The TPDI data may include a PKI digital certificate, a public key, or any other information related to the corresponding target server 300 that can accurately and reliably identify the corresponding target server 300 for authentication purposes. The target device records 264 may be populated from data received directly from the respective target server(s) 300. Additionally, the target device records 264 may be populated from batch data received from, for example, a secure database (not shown) or the target server(s) 300.

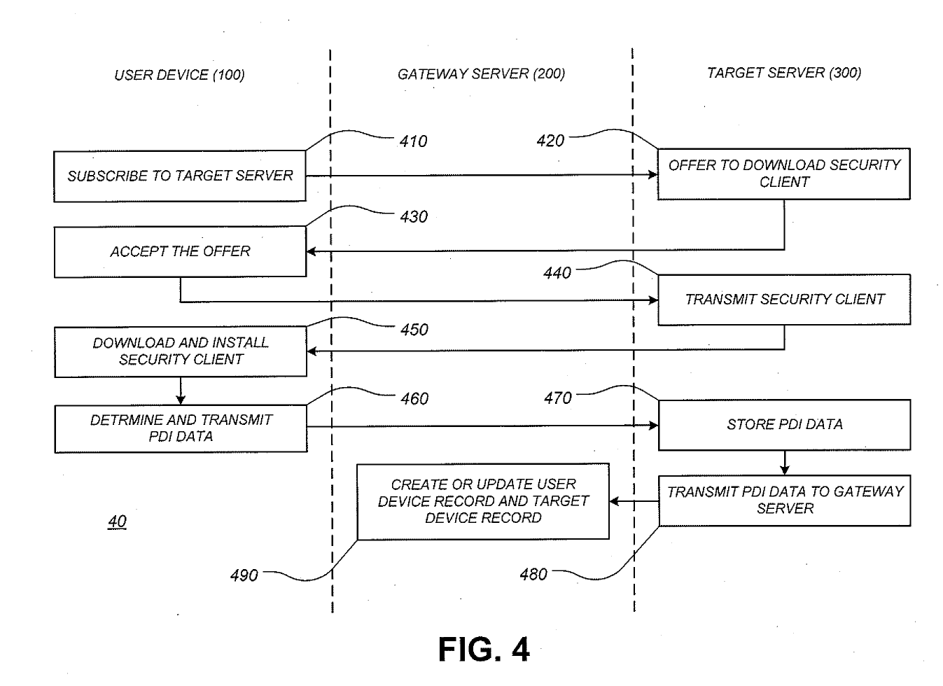

FIG. 4 illustrates an example of an initialization process 40 of the gateway system 10, according to the principles of the disclosure. The initialization process 40 may be carried out by the user device 100, gateway server 200, and target server 300. The POI device 400 may not be involved in the initialization process 40.

The initialization process 40 may be provided as computer program that includes sections of code for each of the steps of the process, which may be embodied in a computer readable medium that may be read and executed by the devices described herein, as understood by those skilled in the art.

Referring to FIGS. 1 and 4, initially the user device 100 may subscribe to the target server 300 (Step 410). The user device 100 may accomplish this, for example, via the network interface 130 (shown in FIG. 2) calling a specific telephone number, accessing a predetermined webpage on the target server 300 (or gateway server 200), or the like. The communication session may use TCP/IP, or any other protocol as understood by those skilled in the art. The target server 300 may respond to the user device 100 by offering to download an authentication program (or “security client”) (Step 420). The offer may be presented on the user device 100 as an SMS text message, a pop-up on a webpage, a link on the webpage, a voice-response signal, or the like, offering the user a downloadable copy of the security client, which may be a mobile app.

If the user device 100 elects to download the security client (Step 430), the target server 300 may transmit the security client to the user device 100 (Step 440). If the user device 100 declines to download the security client or does not accept the offer for a predetermined period of time (e.g., one hour, 12 hours or 24 hours), the process 30 may terminate (not shown). The security client may be transmitted using, for example, TCP/IP data packets.

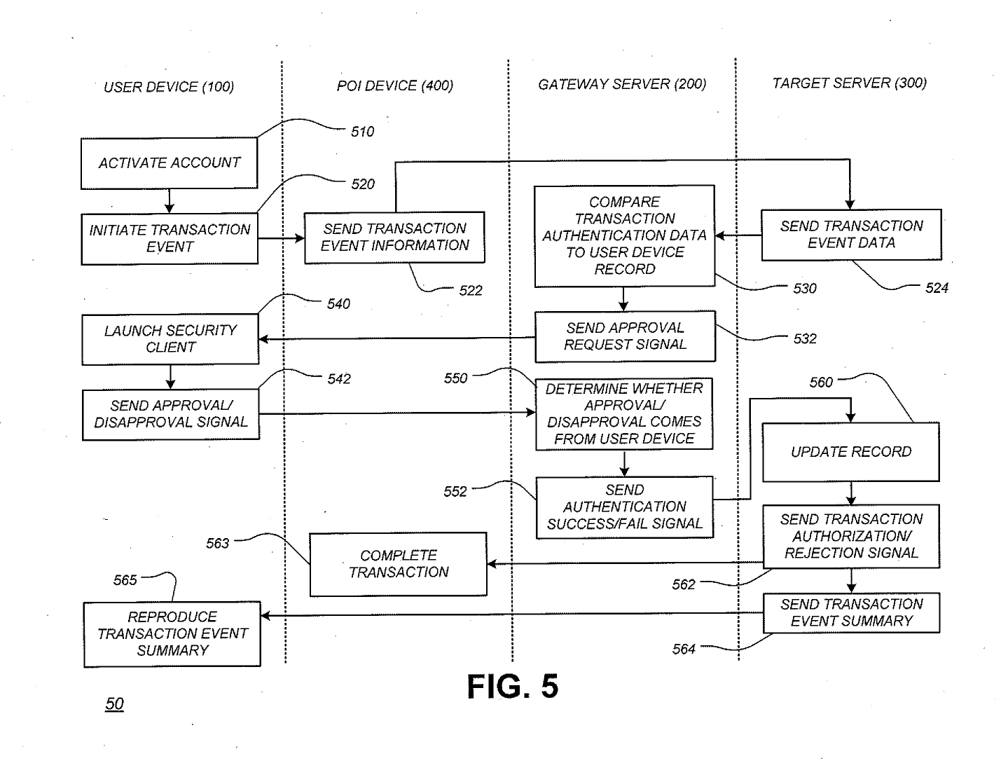

Once the security client is received and downloaded at the user device 100, the processor 110 (FIG. 2) may install the security client on the user device 100 (Step 450), which may reside in the storage 120 as the application program 126. As part of the installation process (Step 450), the user of the user device 100 may be prompted to set a password and/or biometric information, such as, for example, a finger print, a retinal scan, or the like. The password and/or biometric information may be required at all subsequent times to access and run an authentication process, which is described below with reference to FIG. 5. Once the installation is completed, the security client may allow the user device 100 to communicate with the gateway server 200 and the target server 300 in a secure manner.

After, or during installation of the security client on the user device 100 (Step 450), PDI data may be determined for the user device 100 and transmitted to the target server 300 (Step 460). As noted above, the PDI data may include the user device 100's IMSI number, ICCID number, or the like. The PDI data may include a PKI digital certificate, a public key, or any other information related to the user device 100 that can accurately and reliably identify the particular user device 100 for authentication purposes.

Upon receiving the PDI data for the particular user device 100, the PDI data may be stored in a storage, for example, the database (not shown) of the target server 300, and associated with the user data for the user device 100 and/or communication session (Step 470). The user data may include, for example, a first, middle, and last name, a membership number, a login ID, a password, a social security number, a street address, an email address, a telephone number, an image of the user, a bank account number, a credit card number, a passport number, a driver license number, an employee number, or the like. The target server 300 may transmit the PDI data for the particular user device 100 to the gateway server 200 (Step 480), which may occur during an existing communication session. If an existing communication session is not active, the target server 300 may open a communication session (e.g., after completing an initializing authentication procedure) with the gateway server 200 to transmit the PDI data.

Upon receiving the PDI data from the target server 300, the gateway server 200 may create or update the user device record 262 and target device record 264 (shown in FIG. 3) with the received PDI and TPDI data, respectively, as well as data that links the particular user device record 262 with the target device record 264 (Step 490), and the initialization process 40 may terminate.

It is noted that the entire initialization process (Steps 410-490) may be carried out during a single communication session. It is further noted that the communications and downloading of the security client (Steps 410-440), as well as the user PDI data collection, may be handled by the gateway server 200, instead of the target server 300. Furthermore, the gateway server 200 may be combined with the target server 300 into a single server, instead of two separate servers that may be located at different locations.

FIG. 5 illustrates an example of an authentication process 50, according to the principles of the disclosure, which may be carried out by the gateway system 10. As is evident from the description herein, all account information in the gateway system 10 may be by default “offline” and not accessible to third parties, which means that if the account is compromised, fraudsters will not be able to access it. The gateway system 10 may allow the user device 100 to activate and authenticate a transaction event, giving the user device 100 control over a given transaction event. The gateway system 10 may secure the user of the user device 100 from fraudsters, even if user data has been compromised.

The authentication process 50 may be provided as computer program that includes sections of code for each of the steps of the process, which may be embodied in a computer readable medium that may be read and executed by the devices described herein, as understood by those skilled in the art.

Referring to FIGS. 1 and 5, before initiating a transaction event, a user of the user device 100 (e.g., mobile phone) may activate his/her account using the security client installed on the user device 100 (Step 510). Once the account is active, the user may then visit a physical or a virtual POI location that has a POI device 400 and initiate a transaction event (Step 520). The transaction event will depend on the particular application of the gateway system 10. For instance, the transaction event may include purchasing an item at the POI location using a credit or debit card. In this example, the user may swipe or insert a credit/debit card at a merchant point-of-sale (POS) terminal (not shown), or manually enter the account information (e.g., credit card, debit card, gift card, bank account, or the like) in a data entry field (e.g., display field presented on the user device 100, on a vendor terminal, or the like).

According to another example, the transaction event may include gaining access to a secure physical location by scanning, swiping, or inserting an identification card (e.g., an employee identification card) at the POI device 400 that includes a card reader, or keying in the relevant identification information (e.g., employee number, passport number, driver license number, or the like) at the POI device 400. Accordingly, an employee's remote access to a secure network may be authenticated using the multi-factor authentication disclosed herein. Other applications of the gateway system 10 will be evident to those skilled in the art, without departing from the scope or spirit of the disclosure.

Referring to the first non-limiting example, a user may visit a merchant location (e.g., a shop or store) and swipe a credit card at a POI device 400 or provide an online payment service information (e.g., Paypal®, Apple Pay®, Google Wallet®, etc.) at the merchant location to initiate a transaction event (Step 520). After reading the information on the credit card, including bank information and credit card account information, or obtaining the online payment service information via, for example, a near filed communication (NFC) with the user device 100, the POI device 400 may contact and open a communication session with the target server 300, which in this example may be located at a financial institution (e.g., credit card company, bank, etc.). The POI device 400 may then transmit a transaction event information signal that includes data related to the transaction event, including, for example, payment method information (e.g., credit card number), an identification of the merchant, the amount of the purchase, a description of the item purchased, and the like, to the target server 300 (Step 522). At the target server 300, which maintains the account information for the particular user of the user device 100 in a default “do not authorize payment” status, the transaction event data may be parsed from the transaction event information signal received from the POI device 400, reassembled with necessary transaction authentication data and transmitted to the gateway server 200 in a transaction authentication data signal (Step 524). The transaction authentication data signal may include the PDI data associated with the particular user device 100 (and/or user).

Referring to FIGS. 1, 3 and 5, after receiving the transaction authentication data signal (which may include the transaction event data) from the target server 300, the gateway server 200 may access the LUT storage 260 (shown in FIG. 3) and, with respect to the associated target server 300, compare the received transaction authentication data to the data in the user device records 262 (Step 530). Once a match is determined, the gateway server 200 may transmit an approval request signal to the identified user device 100 (Step 532). If a match is not determined (Step 530), then a message may be sent to the target server 300 to notify it that no record exists for such user.

Upon receiving the approval request signal from the gateway server 200 with the information pertaining to the transaction, the user device 100 may automatically activate and launch the security client installed therein (Step 540). Alternatively, the user device 100 may be configured during installation (Step 450 in FIG. 4) not to take any action unless the user manually launches the security client using, for example, a graphic user interface (e.g., I/O interface 140, shown in FIG. 2).

Once the security client is activated, the user may be prompted by the user device 100 whether to approve or reject the transaction event (Step 542). In this regard, the user may be initially prompted to enter a password or biometric identifier to access the security client. Having access to the security client, the user may be prompted with the options of approving authorization of payment for the identified purchase, or disapproving payment. If the user elects to approve the payment, the security client may control the user device 100 to transmit an approval signal to the gateway server 200 (Step 542). The approval signal may include the PDI data for the user device 100. Upon receiving the approval signal, including the PDI data, the gateway server 200 may reference the appropriate user device record 262 (FIG. 3) and determine whether the approval signal was received from user device 100 based on the embedded PDI data (Step 550). If the gateway server 200 determines that the approval signal was received from the appropriate user device 100, then the gateway server 200 may generate and transmit an authentication success signal to the target server 300 for the particular transaction event (Step 552).

If the user elects to disapprove the transaction event (e.g., payment), the user device 100 may transmit a disapproval signal to the gateway server 200 (Step 542); or, the security client may be configured not to send a signal, in which case the authorization process may be terminated by the gateway server 200 after a predetermined amount of time (e.g., 30 seconds, 1 minute, 5 minutes, etc.). The PDI data may be included in the disapproval signal. Upon receiving the disapproval signal, or the predetermined amount of time passing, the gateway server 200 may determine that the transaction event has not been authorized, and generate and transmit an authentication fail signal to the target server 300 for the particular transaction event (Step 552).

After receiving the authentication success or fail signal (Step 552), the target server 300 may update the record for the particular user account, accordingly (Step 560). The target server 300 may then transmit a transaction event authorization or rejection signal to the POI device 400 (Step 562), and the POI device 400 may complete the transaction (Step 563).

Optionally, the target server 300 may transmit a transaction event summary to the user device 100 (Step 564), which may be reproduced (e.g., displayed or announced) on the user device 100 (Step 565), including, for example, the amount, date, and time of the transaction, as well as the merchant's name. The transaction event summary may be transmitted to the security client, which then may cause the user device 100 to display or announce the message; or, as an email, an SMS message, MMS message, or the like; or the like.

As noted earlier, the gateway server 200 and target server 300 may be combined, such as, for example, a single serve. In this regard, the steps carried out by the gateway server 200 and target server 300 would be carried out by the single server. It is noted that in the context of a server cloud, the functions of the gateway server 200 and target server 300 may be combined in the cloud.

In the present disclosure, all account information may be set by default to “offline” and not accessible, which means that if the account is compromised in any way, fraudsters won't be able to access it. The disclosure provides a system that allows a user to activate and authenticate a transaction (or his account information) by using a user device 100. This process secures the user's account from fraudsters, even if user data has been compromised. The secure gateway system disclosed herein may be deployed on the issuing side, such as by, for example, a bank, a financial institution, an insurance company, a government entity, or any other type of business.

The gateway system includes a security client that may be installed on the user device 100 and that may hold a secure and identified connection to the gateway server 200. The security client, which may be an application downloaded to the user device 100 over the air, may have secure channels to the gateway server 20 in which a secure transaction may be executed. It is possible for the target server to add and revoke services. The security client is a security entity, but regarding services and graphic user interface (GUI) features, it may be provided as a thin client that displays server-side services and GUI on the user device 100.

The gateway system 10 may include a multi-factor public key infrastructure (PKI) authentication platform where the security client is installed on a user device 100. The security client may communicate securely over a TCP/IP communication link with a target 300 (or gateway 200) server that in turn communicates with external systems through standard API's. When a user starts the security client, a connection to the target (or gateway) server may be established and the user device's (and, therefore, user's) identity is verified. Once verified, the user can perform various kinds of secure authentications.

The authentication may be executed by the user entering a password in the user device 100 via the security client. The identity may be already predefined at the target (or gateway) server. The security client may be connected to the back-end of the gateway (or target) server, which matches the PDI with the PDIs defined at the server. When a valid PDI is matched, a confirmation request is sent to the user device 100 with the details of the transaction and request for acceptance.

By providing a secure and identified enrolment process where the user device 100 (and, therefore, the user) is identified using multi-factor authentication (e.g., two-factor authentication (2FA)), the integrity of the user may be kept. The system's inclusion of several layers of security help to retain this integrity and further strengthen and ensure that only the person that is registered to the service and the owner/holder of the user device can approve a transaction event.

A “computer,” as used in this disclosure, means any machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a super computer, a personal computer, a laptop computer, a palmtop computer, a notebook computer, a desktop computer, a workstation computer, a server, or the like, or an array of processors, microprocessors, central processing units, general purpose computers, super computers, personal computers, laptop computers, palmtop computers, notebook computers, desktop computers, workstation computers, servers, or the like.

A “server,” as used in this disclosure, means any combination of software and/or hardware, including at least one application and/or at least one computer to perform services for connected clients as part of a client-server architecture. The at least one server application may include, but is not limited to, for example, an application program that can accept connections to service requests from clients by sending back responses to the clients. The server may be configured to run the at least one application, often under heavy workloads, unattended, for extended periods of time with minimal human direction. The server may include a plurality of computers configured, with the at least one application being divided among the computers depending upon the workload. For example, under light loading, the at least one application can run on a single computer. However, under heavy loading, multiple computers may be required to run the at least one application. The server, or any if its computers, may also be used as a workstation.

A “database,” as used in this disclosure, means any combination of software and/or hardware, including at least one application and/or at least one computer. The database may include a structured collection of records or data organized according to a database model, such as, for example, but not limited to at least one of a relational model, a hierarchical model, a network model or the like. The database may include a database management system application (DBMS) as is known in the art. The at least one application may include, but is not limited to, for example, an application program that can accept connections to service requests from clients by sending back responses to the clients. The database may be configured to run the at least one application, often under heavy workloads, unattended, for extended periods of time with minimal human direction.

A “communication link,” as used in this disclosure, means a wired and/or wireless medium that conveys data or information between at least two points. The wired or wireless medium may include, for example, a metallic conductor link, a radio frequency (RF) communication link, an Infrared (IR) communication link, an optical communication link, or the like, without limitation. The RF communication link may include, for example, WiFi, WiMAX, IEEE 802.11, DECT, 0G, 1G, 2G, 3G or 4G cellular standards, Bluetooth, and the like.

A “network,” as used in this disclosure means, but is not limited to, for example, at least one of a local area network (LAN), a wide area network (WAN), a metropolitan area network (MAN), a personal area network (PAN), a campus area network, a corporate area network, a global area network (GAN), a broadband area network (BAN), a cellular network, the Internet, or the like, or any combination of the foregoing, any of which may be configured to communicate data via a wireless and/or a wired communication medium. These networks may run a variety of protocols not limited to TCP/IP, IRC or HTTP.

The terms “including,” “comprising” and variations thereof, as used in this disclosure, mean “including, but not limited to,” unless expressly specified otherwise.

The terms “a,” “an,” and “the,” as used in this disclosure, means “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

Although process steps, method steps, or the like, may be described in a sequential order, such processes and methods may be configured to work in alternate orders. In other words, any sequence or order of steps that may be described does not necessarily indicate a requirement that the steps be performed in that order. The steps of the processes or methods described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

While the disclosure has been described in terms of exemplary embodiments, those skilled in the art will recognize that the disclosure can be practiced with modifications in the spirit and scope of the appended claim, drawings and attachment. The examples provided herein are merely illustrative and are not meant to be an exhaustive list of all possible designs, embodiments, applications or modifications of the disclosure.

What is claimed is:

1. A gateway system for authenticating a transaction event, comprising:
a target server that receives a transaction event information signal from a point of inquiry (POI) device, the transaction event information signal including transaction event data associated with a user device; and
a gateway server that sends an approval request signal for the transaction event data to the user device,
wherein the target server sends a transaction authorization signal to the POI device when the gateway server receives a transaction approval signal from the user device.

2. The gateway system of claim 1, wherein the user device comprises a security client that is activated when the user device receives the approval request signal from the gateway server.

3. The gateway system of claim 2, wherein the security client controls the user device to send the transaction approval signal to the gateway server.

4. The gateway system of claim 1, wherein the gateway server determines whether the transaction approval signal is received from the user device.

5. The gateway system of claim 4, wherein the gateway server comprises a storage containing predefined identity (PDI) data of one or more user devices,
wherein the transaction approval signal comprises the PDI data of the user device, and
wherein the gateway server determines that the transaction approval signal is received from the user device when the PDI data of the user device is found in the storage.

6. The gateway system of claim 5, wherein the PDI data comprises at least one of an international mobile subscriber identity (IMSI) number, an integrated circuit card identifier (ICCID), a public key infrastructure (PKI) digital certificate, and a public key of the user device.

7. The gateway system of claim 1, wherein the target server sends a transaction event data signal to the gateway server when the transaction event information signal is received from the POI device.

8. The gateway system of claim 7, wherein the gateway server determines whether the transaction event data signal is received from the target server.

9. The gateway system of claim 8, wherein the gateway server comprises a storage containing target predefined identity (TPDI) data of one or more target servers,
wherein the transaction event data comprises TPDI data of the target server, and
wherein the gateway server determines that the transaction event data signal is received from the target server when the TPDI data of the target server is found in the storage.

10. A method for operating a gateway server, the method comprising:
receiving, at the gateway server, a transaction event data signal from a target server, the transaction event data signal containing transaction event data associated with a user device;
sending, from the gateway server, an approval request signal to the user device associated with the transaction event data;
receiving, at the gateway server, an approval signal for the transaction event from the user device; and
sending, from the gateway server, an authentication success signal to the target server.

11. The method of claim 10, wherein the transaction event data signal is generated by the target server based on a transaction event information signal received from a point-of-inquiry (POI) device.

12. The method of claim 11, wherein the target server sends a transaction authorization signal to the POI device after receiving the authentication success signal.

13. The method of claim 10, further comprising determining whether the transaction event data signal is received from the target server.

14. The method of claim 13, wherein the transaction event data signal comprises a target predefined identity (TPDI) data of the target server,
wherein the gateway server comprises a storage containing TPDI data of one or more target servers, and
wherein the determining comprises searching the TPDI data of the target server in storage.

15. The method of claim 10, further comprising determining whether the approval signal for the transaction event is received from the user device.

16. The method of claim 15, wherein the approval signal comprises predefined identity (PDI) data of the user device,
wherein the gateway server comprises a storage containing predefined identity (PDI) data of one or more user devices, and
wherein the determining comprises searching the PDI data of the user device in the storage.

17. A gateway server, comprising:
a network interface that receives a transaction event data signal from a target server, the transaction event data signal comprising transaction event data associated with a user device;
a data storage that stores a user device record of the user device associated with the transaction event data; and
a processor that identifies the user device based on the transaction event data,
wherein the network interface sends an approval request signal to the user device and receives an approval signal for the transaction event from the user device.

18. The gateway server of claim 17, wherein the network interface sends an authentication success signal to the target server when the approval signal is received from the user device.

19. The gateway server of claim 17, wherein the processor determines whether the approval signal is received from the user device.

20. The gateway server of claim 17, wherein the processor determines whether the transaction event data is received from the target server.
